(19) United States
(12) Patent Application Publication
(10) Pub. No.: US 2010/0148674 A1
(43) Pub. Date: Jun. 17, 2010

(54) SETTING AN RGB LUMINOUS MODULE

(75) Inventors: Paul Braun, Meitingen (DE); Harald Dellian, Edling (DE); Peter Hummel, Muenchen (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/626,955

(22) Filed: Nov. 30, 2009

(30) Foreign Application Priority Data
Dec. 11, 2008 (DE) 10 2008 061 777.6

(51) Int. Cl. H05B 37/02

(52) U.S. Cl. 315/149

(57) ABSTRACT

An arrangement for setting at least one RGB luminous module is provided. The arrangement may include at least one RGB sensor configured to detect a color signal; and a processor configured to set the at least one RGB luminous module depending on the color signal.

### CROSS-REFERENCE TO RELATED APPLICATION

This application claims priority to German Patent Application Serial No. 10 2008 061 777.6, which was filed Dec. 11, 2008, and is incorporated herein by reference in its entirety.

### TECHNICAL FIELD

Various embodiments relate to an arrangement and also a method for setting an RGB luminous module. A corresponding luminaire or lamp and also a remote control are furthermore proposed.

### BACKGROUND

The setting of an RGB-capable luminous module on the basis of predefinable colors is laborious and not very intuitive. In particular, it is difficult to map a specific color perceived as pleasant onto the RGB luminous module manually.

In particular, it is disadvantageous that illumination based on image information of a video signal is extremely complex since it has been the case hitherto that the image signal itself is correspondingly processed for this purpose. This largely prevents retrofit solutions for illumination depending on an image signal, e.g. a television picture.

### SUMMARY

An arrangement for setting at least one RGB luminous module is provided. The arrangement may include at least one RGB sensor configured to detect a color signal; and a processor configured to set the at least one RGB luminous module depending on the color signal.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a block diagram for the driving of an RGB luminous module with the aid of an RGB sensor;

FIG. 2 shows a block diagram with an alternative driving of the RGB luminous module with the aid of the RGB sensor by means of a microcontroller;

FIG. 3 shows a block diagram including two arrangements in accordance with FIG. 2 for the (different) driving of two RGB luminous modules;

FIG. 4 shows a possible application scenario for the block diagram in accordance with FIG. 3 including equipment with cabinets and shelves, wherein the equipment has a television set and also a plurality of RGB luminous modules; and

FIG. 5 shows a remote control for setting an RGB luminous module.

### DESCRIPTION

The following detailed description refers to the accompanying drawings that show, by way of illustration, specific details and embodiments in which the invention may be practiced.

Various embodiments make it possible to set an RGB luminous module by means of at least one RGB sensor.

In various embodiments, the RGB sensor can pick up the color information of an original, of an image or of a color chart, and the RGB luminous module can be driven depending on this color information.

The RGB luminous module may include at least one RGB light source, e.g. a multiplicity of RGB light sources, which are arranged e.g. in the form of a plurality of RGB LEDs in a row or in some other form.

By way of example, the at least one RGB sensor supplies a voltage signal and/or a frequency signal. Such a signal can be amplified and forwarded to an RGB control unit for driving the RGB luminous module. By way of example, it is possible for the voltage signal and/or the frequency signal of the at least one RGB sensor to be converted into frequency information, e.g. in the form of a pulse width modulation (PWM), by means of a microprocessor or by means of a microcontroller and to be used in this way for driving the RGB luminous module.

In this case, it may be provided in various embodiments that no complex processing and/or inputting of a color is necessary for correspondingly driving the RGB luminous module. By way of example, a user can individually select a color that is pleasant to said user, e.g. on a computer screen, and can set the RGB luminous module in accordance with the selected color by means of the RGB sensor.

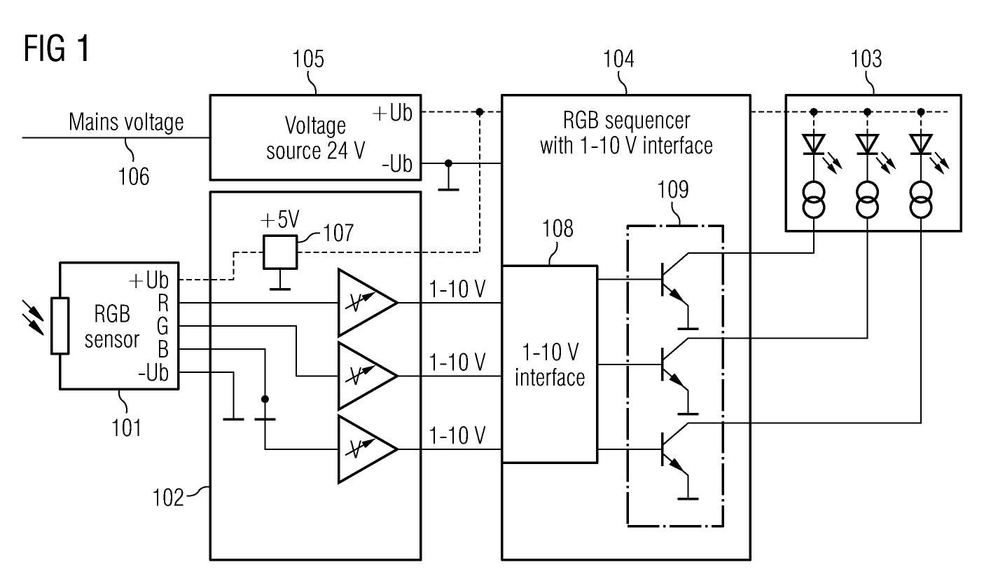

FIG. 1 shows a block diagram for the driving of an RGB luminous module 103 with the aid of an RGB sensor 101.

A mains voltage 106 is converted to a DC voltage of 24V in a power supply unit 105 and provided at outputs +Ub and −Ub (ground potential) of the power supply unit 105.

The voltage of +Ub=24V is fed to a voltage amplifier 102, which, by means of a voltage regulator 107, generates a voltage of +5V for the operation of the RGB sensor 101 and provides it to the latter. The RGB sensor 101 and the voltage amplifier 102 are connected to the ground potential. Furthermore, the RGB sensor 101 supplies to the voltage amplifier 102 voltages for the color components red R, green G and blue B, which, in the voltage amplifier, are converted to a voltage in a range of 0V to 10V and forwarded to an RGB controller 104.

The RGB controller 104 is furthermore connected to the power supply unit 105 and includes an interface 108, which processes three signals for the color components red R, green G and blue B in a range of 0V to 10V. The RGB controller 104 furthermore includes a driver stage 109 for driving the RGB luminous module 103, that is to say for separately driving each color component red R, green G and blue B in the RGB luminous module 103.

The RGB luminous module 103 can be connected to the supply voltage +Ub via the RGB controller 104, for example, which are connected e.g. to the cathodes of the light emitting diodes arranged in the RGB luminous module 103. Each of the light emitting diodes can be connected via a current source to the respective color component red R, green G or blue B provided by the RGB controller 104.

The brightnesses of the individual RGB luminous sources in the RGB luminous module 103 can be set by means of pulse width modulation, for example.

In various embodiments, current sources are provided for this purpose on the RGB luminous module, e.g. one respective constant-current source for each color component R, G and B. Such a constant-current source is driven by means of pulse width modulation for setting the brightness of the respective color component. As an alternative, it is also possible for constant-current sources to be provided e.g. in the RGB controller 104 and to be driven correspondingly. In such a case, the RGB module can manage without dedicated current sources.

The RGB luminous module 103 can have a multiplicity of RGB luminous sources, e.g. light emitting diodes. In various embodiments, a plurality of RGB luminous modules can be interconnected.

The RGB sensor 101 measures the incident color spectrum of the light and provides a signal proportional thereto at the outputs R, G, B. By way of example, the signal provided is a voltage in a range of 0V to 3V per color component R, G, B in accordance with the intensity of the incident light.

The light can act on the RGB sensor 101 directly or optically (e.g. via lenses, fiber-optic line or the like).

The voltage amplifier 102 amplifies the signals of the color components R, G, B of the RGB sensor 101 e.g. with a gain factor of V=3.5 and thus generates for the color components R, G and B a respective signal in a voltage range of 0V to 10V.

The amplified signal (0-10V) is applied to the control input (1-10V) of the RGB controller 104, e.g. an RGB PWM controller. Per color signal R, G, B, a PWM signal for the operation of an associated RGB LED is generated by the RGB controller 104.

By way of example, as RGB luminous module 103, LED modules in the form of “24V RGB linear light modules” can be used (with an integrated constant-current source).

The power supply unit 105 generates the 24V DC voltage for supplying the components illustrated in FIG. 1.

In various embodiments, the measured color information is passed on to the RGB luminous sources of the RGB luminous module 103 directly without alteration or modification of the color components. Depending on the calibration, a color-faithful rendering of the color information detected by the sensor can thus be effected in an efficient manner. Accordingly, the brightness from the RGB sensor can be correspondingly mapped. Exemplary applications include a simulation of a sunrise, a sunset, daylight e.g. for aquariums, windowless rooms, animal enclosures or the like.

Furthermore, it is possible to set or predefine the color information using simple means; by way of example, a color and/or brightness of a room light can be effected by means of a mouse with an RGB sensor by the mouse being moved over or on a color chart.

Furthermore, color control is also possible in time-controlled fashion, e.g. by means of a clock. Thus, a pointer (e.g. hour hand of an analog clock) could have the RGB sensor and be moved over a dial with different colors or color progressions—e.g. coordinated with the course of a day. By way of example, room lighting is thus set automatically depending on the time of day and the color pattern of the dial.

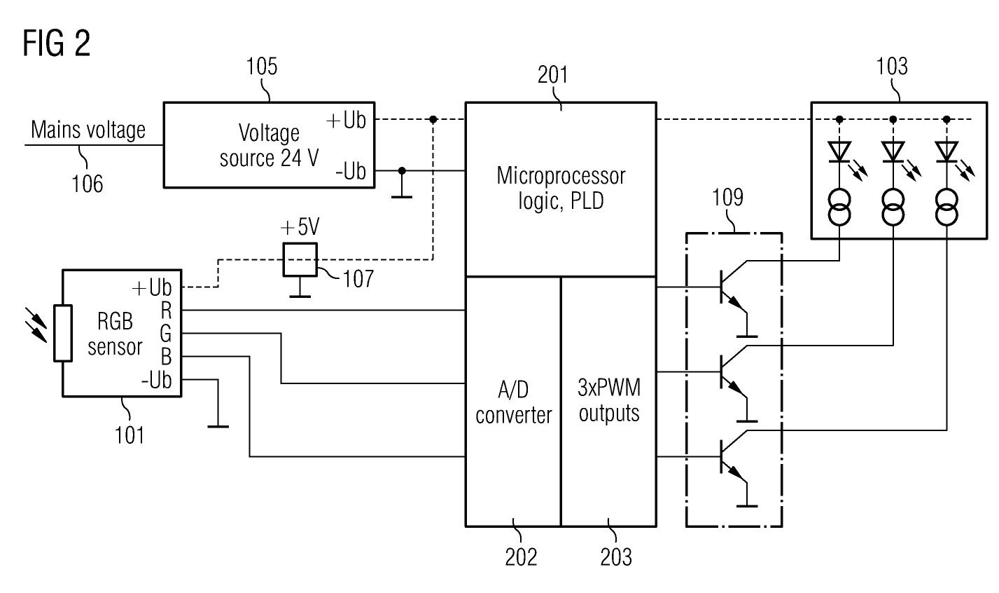

FIG. 2 shows a block diagram for the driving of the RGB luminous module 103 with the aid of the RGB sensor 101 by means of a microcontroller 201.

In a manner corresponding to FIG. 1, FIG. 2 also has the RGB sensor 101, the power supply unit 105, the voltage regulator 107 for supplying the RGB sensor 101, the driver stage 109 and also the luminous module 103. The explanations above with regard to FIG. 1 are in this respect correspondingly applicable to the exemplary embodiment in accordance with FIG. 2 as well.

The RGB sensor 101 measures the incident light and directs a signal that is proportional depending on the color component R, G, B directly to an A/D converter 202 of the microcontroller 201. The signals R, G, B can be in each case voltage- or frequency-dependent signals.

The microcontroller 201 generates corresponding output signals from the detected A/D converted signals via three PWM outputs 203, said output signals being used for driving the light sources of the luminous module 103 via the driver stage 109. In various embodiments, the luminous module has per color component a dedicated light emitting diode that can be operated via a constant-current source.

Depending on the resolution of the measured voltage values, the PWM resolution can be chosen correspondingly, e.g. 3 times 8 bit A/D=3×8 bit PWM).

A further embodiment consists in providing one RGB sensor or a plurality of RGB sensors for picking up a screen content. It is correspondingly possible to use a plurality of RGB sensors at different positions of a screen or for picking up the color information and/or brightness of a plurality of positions of the screen and to set, in a manner dependent thereon, e.g. ambient lighting—including in a position-dependent manner—from at least one RGB luminous module, in particular for a plurality of RGB luminous modules at different positions.

Thus, by way of example, color information of a screen content, of an image or of a projection, with one RGB sensor or with a plurality of RGB sensors, can be converted into a voltage signal or into a frequency signal.

The color information can be detected by the RGB sensors by means of optical waveguides or optical units (lenses). The color information detected by the RGB sensors can be fed to an RGB controller in amplified or non-amplified fashion. The RGB controller can perform calculations for the color control and correspondingly drive the RGB luminous modules by means of voltage signals or by means of frequency signals (PWM).

In this case, it may be achieved that no complex processing of the video signal, e.g. in a television, video recorder or screen, is necessary. The solution presented here can be offered and sold as a retrofit kit independently of the screen medium. It is neither necessary to intervene in the screen nor necessary to tap an image signal line. The retrofit kit can be fitted to existing components, e.g. to an existing television. In particular, optical units (e.g. lenses), can be provided, which permit flexible fitting to virtually any screens or projection surfaces. By way of example, a screen content could be evaluated by means of the corners and/or edges. RGB sensors can be correspondingly fitted there. The number of RGB luminous modules or RGB light sources can be chosen freely. Moreover, further RGB luminous modules can be connected in order to permit additional lighting e.g. of adjacent furniture, pictures, or the like by means of controllable RGB light sources.

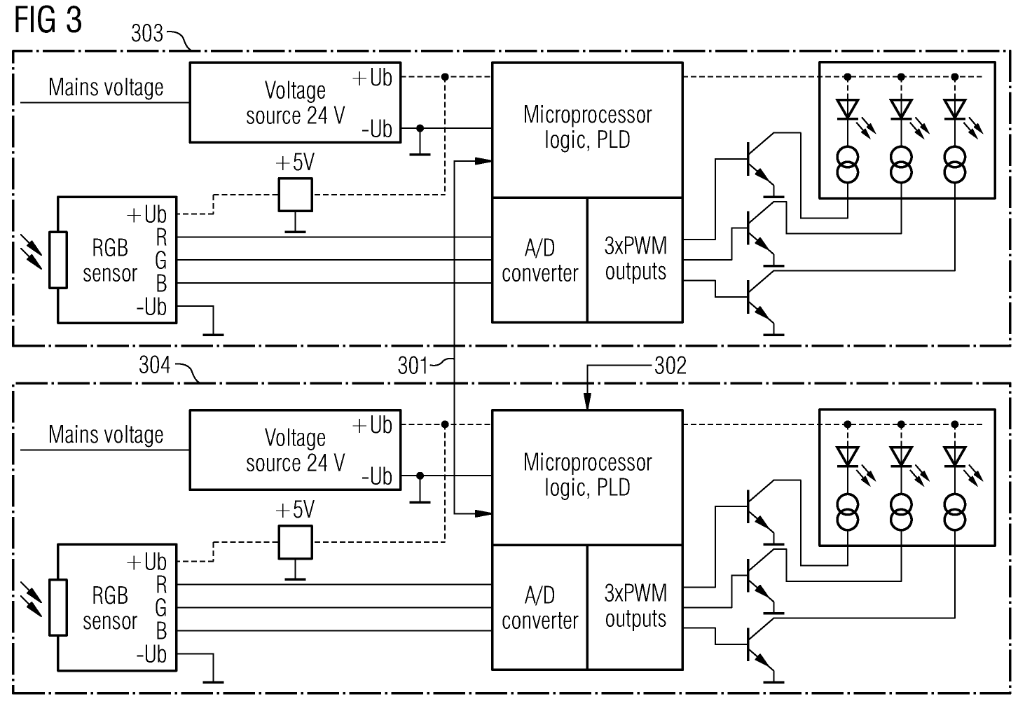

FIG. 3 shows a block diagram including two arrangements 303 and 304 in accordance with FIG. 2. The microcontrollers of the arrangements 303 and 304 are connected to one another via a communication line 301. Furthermore, a possibility for manual inputting 302 can be provided for at least one microcontroller.

By way of example, the arrangement 303 can be provided for a left screen half in such a way that the RGB sensor of the arrangement 303 detects RGB information of the left screen half. The associated RGB luminous module of the arrangement 303 can illuminate e.g. a background in the vicinity of the left screen half in accordance with the detected RGB signal. The arrangement 304 can correspondingly be provided for a right screen half, such that the RGB sensor of the arrangement 304 essentially converts the (or part of the) right screen half into RGB information, which is correspondingly converted e.g. as background lighting by the RGB luminous module of the arrangement 304.

In this case, it should be noted that, by way of example, one power supply unit of one of the arrangements 303 or 304 can perform the function of the respective other power supply unit. In this case, one power supply unit can be omitted for the two arrangements 303 and 304.

Furthermore, it is possible for only a single microcontroller to be provided, to which a plurality of RGB sensors can be connected and which, if appropriate, can drive a multiplicity of RGB luminous modules. In various embodiments, it is an option for the number of RGB sensors to differ from the number of RGB luminous modules.

In accordance with the above explanations with regard to FIG. 2, the RGB sensor of the respective arrangement 303, 304 measures the incident light and communicates a signal proportional to this light to the microcontroller. Said signal can include a voltage or a frequency. In the example in accordance with FIG. 3, the color information of a screen half is detected by the respective RGB sensor via optical lenses, for example.

The signal detected and provided by the RGB sensor is converted into a PWM signal by the microcontroller by means of an A/D conversion, on the basis of which PWM signal at least one RGB luminous module is driven via a driver stage, wherein the RGB luminous module preferably has a constant-current source.

Depending on a resolution of the voltage values measured by the RGB sensor, a resolution of the PWM can be chosen correspondingly. By way of example, a 3×8 bit A/D signal can be converted into a 3×8 bit PWM signal.

Between the two arrangements 303 and 304, a coordination of the color information can be effected via the communication line 301. By way of example, uniform color outputting or color adjustment for compensation of high color contrasts can thereby be effected.

By way of example, the measured colored information can be weighted (e.g. by means of a moving average value, by determining slow changes, by means of color adjustment of the two RGB luminous modules), and the associated RGB luminous modules can be driven by means of the PWM signals.

Furthermore, e.g. color selection, brightness, color change or additional settings can be performed by means of the manual inputting 302.

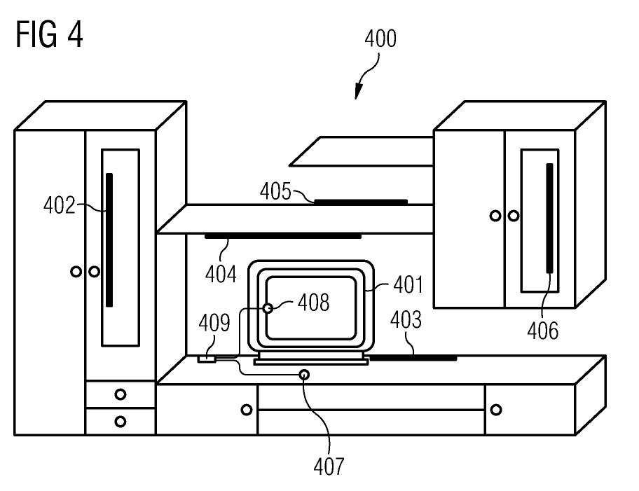

FIG. 4 shows one possible application scenario for the block diagram in accordance with FIG. 3. Equipment 400 includes cabinets and shelves, wherein a television set 401 and also a plurality of RGB luminous modules 402 to 406 are provided in the equipment 400.

Furthermore, evaluation electronics 409 and also for example two RGB sensors 407 and 408 connected to the evaluation electronics 409 may be present. Furthermore, the RGB luminous modules 402 to 406 are connected to the evaluation electronics 409. The evaluation electronics include for example the components shown in FIG. 1 or FIG. 2, inter alia a power supply unit, a voltage amplifier with RGB controller or respectively a microcontroller, and also at least one driver stage. In this case, it should be noted that parts of the stated components described above can also be implemented together with the RGB luminous modules 402 to 406.

The RGB sensors 407 and 408 supply location-dependent RGB information that can be used in accordance with the positioning of the RGB luminous modules 402 to 406 for illuminating the surroundings.

It is thus possible that, by way of example, the left region around the television set 401 is correspondingly illuminated with a different hue than the lower region around the television set 401.

Another embodiment relates to an advantageous possibility of adjusting or setting LEDs to existing color surfaces. Moreover, it is possible to correspondingly pick up color sequences. In this case an RGB sensor can be integrated into a remote control and, by means of the remote control, an RGB luminous module can be driven or set in accordance with the at least one color signal detected. For reading in a color sequence or a succession of colors, the remote control can be guided over a varicolored surface. Afterward or during this the data can be transmitted to the RGB luminous module, e.g. to an RGB-capable luminaire.

An infrared interface, a radio interface or some other (including wired) communication interface can be used for transmitting the data.

It is also possible for an RGB luminous module to be set in such a way that as a result substantially white light is generated by virtue of the RGB luminous module generating a complementary color with respect to a predefinable color. By way of example, in rooms in which a wall color or a furniture color dominates, the RGB luminous module can be set at least partly to a color that is complementary to the wall color or furniture color in such a way that as a result substantially an impression of white light appears. This can be achieved by means of the remote control described, for example, by a color of a (dominant) color surface being detected and a desired color temperature (e.g. temperature of a white light) being set by means of the remote control. The complementary color correspondingly required can be determined in the remote control and is transmitted to the RGB luminous module. Optionally, the RGB sensor can also detect a light already set and carry out (more extensive) regulation of the RGB luminous module to the desired color locus on the basis of the currently detected light signal. In various embodiments, for this purpose the remote control can communicate data for setting to the RGB luminous module for a predefinable time period iteratively or continuously.

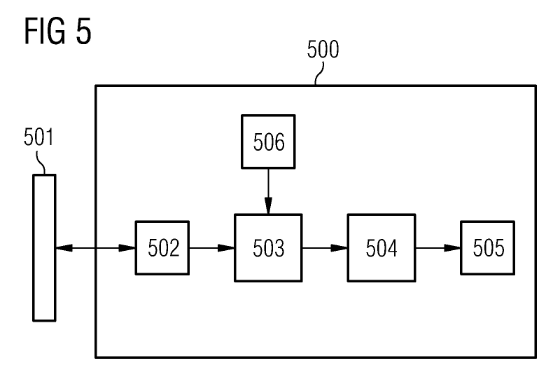

FIG. 5 shows a remote control 500 for setting an RGB luminous module (not illustrated in FIG. 5).

The remote control 500 includes an RGB sensor 502 for detecting an RGB signal within a room or from a surface 501. The signal detected by the RGB sensor 502 is provided to a microcontroller 503. The microcontroller 503 may have a memory, e.g. a flash memory, for storing signals from the RGB sensor 502. Furthermore, the remote control 500 exhibits an operating unit 506, e.g. an operating circuit, in order to carry out a color detection or to communicate a signal determined by the microcontroller 503 to the RGB luminous module. The remote control 500 also has a modulator 504 and an interface 505 for transmitting a signal for setting the RGB luminous module. The interface 505 can be e.g. an infrared (IR) sensor or a radio module.

Accordingly, by way of example, the RGB sensor 101 shown in FIG. 2 can be embodied in mobile fashion in the form of the remote control 500 described; the microcontroller 201 and the power supply unit 105 can be arranged e.g. with or in a luminaire including the at least one RGB luminous module 103. Said remote control 500 can accordingly be used flexibly for setting a multiplicity of RGB luminous modules or luminaires. This can be advantageous particularly if the RGB luminous modules are arranged at locations that are difficult to reach, e.g. high ceilings.

Various embodiments avoid the disadvantages mentioned above and, in various embodiments, provide a simple, rapid and pleasant possibility of illumination by means of an RGB luminous module.

In various embodiments, an arrangement for setting at least one RGB luminous module is specified,
wherein at least one RGB sensor is provided for detecting a color signal,
wherein a processor is provided, which sets the at least one RGB luminous module depending on the color signal.

The RGB sensor supplies, e.g., a voltage signal or a frequency signal proportional to the color component red R, green G and blue B.

One development is for the RGB luminous module to include at least one RGB light source, in particular at least one light emitting diode.

Various embodiments are for the processor to include one of the following components:
a voltage amplifier,
an RGB controller,
a microcontroller,
an A/D converter,
a driver stage, and/or
a pulse width modulation.

Various embodiments are for the at least one RGB sensor to detect a color signal directly or by means of an optical unit, e.g. via at least one lens and/or via a fiber-optic line.

Moreover, various embodiments are for the at least one RGB sensor to be provided for picking up a color signal for at least one part of an image, in particular of a video image or of a projected image.

For this purpose, the at least one RGB sensor may be arranged e.g. at the edge of a video screen, e.g. of a television or of a projector. By way of example, the at least one RGB sensor can also be used for detecting a color signal for at lest one part of a projected image. In various embodiments, a plurality of RGB sensors are provided, e.g. two RGB sensors for the image halves (top/bottom or right/left) or four RGB sensors for corner regions, edge regions or quadrants of an image.

Furthermore, in various embodiments, a plurality of RGB luminous modules can be driven by means of the processor in a manner dependent on the position of said modules with respect to the image.

In the context of various embodiments, the processor is configured to set the at least one RGB luminous module substantially in accordance with the color signal.

Various embodiments consist in the arrangement having an operating unit for setting the at least one RGB luminous module.

Various embodiments are for the arrangement to have an interface for transmitting the color signal to the at least one RGB luminous module.

In various embodiments, the interface for transmitting the color signal can be a radio interface, e.g. an infrared interface.

By way of example, it is possible to set the at least one RGB luminous module (virtually) in real time or at regularly predefined or predefinable points in time. Moreover, a point in time for setting and/or regulating the at least one RGB luminous module can be predefined by a user by means of the operating unit.

In an alternative embodiment, a plurality of color signals can be picked up and can be stored by means of the processor, wherein the at least one RGB luminous module can be set on the basis of the plurality of color signals.

Thus, by way of example, a succession or sequence of colors (color progressions) can be displayed by the at least one RGB luminous module.

In a next configuration, a complementary color with respect to the color signal can be determined with the aid of the processor, and the processor is configured to set the at least one RGB luminous module at least partly on the basis of the complementary color.

This makes it possible, by means of setting the at least one LED luminous module, for an impression of white light to be generated and conveyed even and precisely in the case of correspondingly colored surroundings (colored walls or furniture).

One way of achieving one or more of the effects mentioned above consists in proposing a remote control which is suitable for setting at least one RGB luminous module and has the arrangement described herein.

Another way of achieving the above object is for a luminaire or a lamp to be proposed including at least one RGB luminous module, which luminaire or which lamp can be set by means of an arrangement described herein.

Various embodiments achieve one or more of the above mentioned effects by means of a method for setting at least one RGB luminous module,
wherein at least one RGB sensor is provided, with the aid of which a color signal is detected,
wherein a processor is provided, with the aid of which the at least one RGB luminous module is set depending on the color signal.

### LIST OF REFERENCE SYMBOLS SHOWN IN THE FIGURES

101 RGB sensor
102 Voltage amplifier
103 RGB luminous module
104 RGB controller
105 Power supply unit
106 Mains voltage
107 Voltage regulator
108 Interface of the RGB controller
109 Driver stage
201 Microcontroller
202 A/D converter
203 PWM outputs
301 Communication line
302 Manual inputting
303 Arrangement in accordance with FIG. 2
304 Arrangement in accordance with FIG. 2
400 Equipment
401 Television set
402-406 RGB luminous module
407-408 RGB sensor
409 Evaluation electronics
500 Remote control
501 Surface
502 RGB sensor
503 Microcontroller
504 Modulator
505 Interface

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An arrangement for setting at least one RGB luminous module, comprising:
at least one RGB sensor configured to detect a color signal; and
a processor configured to set the at least one RGB luminous module depending on the color signal.

2. The arrangement as claimed in claim 1, further comprising
the RGB luminous module coupled to the processor.

3. The arrangement as claimed in claim 1,
wherein the RGB luminous module comprises at least one RGB light source.

4. The arrangement as claimed in claim 3,
wherein the RGB luminous module comprises at least one light emitting diode.

5. The arrangement as claimed in claim 1,
wherein the processor comprises at least one of the following components:
a voltage amplifier;
an RGB controller;
a microcontroller;
an A/D converter;
a driver stage; and
a pulse width modulator.

6. The arrangement as claimed in claim 1,
wherein the at least one RGB sensor is configured to detect a color signal at least one of directly and by means of an optical unit, in particular via at least one lens and/or via a fiber-optic line.

7. The arrangement as claimed in claim 6,
wherein the at least one RGB sensor is configured to detect a color signal by means of an optical unit, via at least one of at least one lens and via a fiber-optic line.

8. The arrangement as claimed in claim 1,
wherein the at least one RGB sensor is configured to pick up a color signal for at least one part of an image, in particular of a video image or of a projected image.

9. The arrangement as claimed in claim 8,
wherein the at least one RGB sensor is configured to pick up a color signal for at least one part of at least one of a video image and a projected image.

10. The arrangement as claimed in claim 8,
wherein a plurality of RGB luminous modules are configured to be driven by means of the processor in a manner dependent on the position of the RGB luminous modules with respect to the image.

11. The arrangement as claimed in claim 1,
wherein the processor is configured to set the at least one RGB luminous module substantially in accordance with the color signal.

12. The arrangement as claimed in claim 1, further comprising:
an operating unit configured to set the at least one RGB luminous module.

13. The arrangement as claimed in claim 1, further comprising:
an interface configured to transmit the color signal to the at least one RGB luminous module.

14. The arrangement as claimed in claim 13,
wherein the interface configured to transmit the color signal comprises a radio interface, in particular an infrared interface.

15. The arrangement as claimed in claim 14,
wherein the interface configured to transmit the color signal comprises an infrared interface.

16. The arrangement as claimed in claim 1,
configured such that a plurality of color signals can be picked up and can be stored by means of the processor, wherein the at least one RGB luminous module can be set on the basis of the plurality of color signals.

17. The arrangement as claimed in claim 1,
wherein the arrangement is configured such that a complementary color with respect to the color signal can be determined with the aid of the processor; and
wherein the processor is configured to set the at least one RGB luminous module at least partly on the basis of the complementary color.

18. A remote control for setting at least one RGB luminous module, comprising:
an arrangement for setting at least one RGB luminous module, comprising:
at least one RGB sensor configured to detect a color signal; and
a processor configured to set the at least one RGB luminous module depending on the color signal.

19. A luminaire, comprising:
at least one RGB luminous module;
which luminaire is configured to be set by means of an arrangement for setting at least one RGB luminous module, comprising:
at least one RGB sensor configured to detect a color signal; and
a processor configured to set the at least one RGB luminous module depending on the color signal.

20. A lamp, comprising:
at least one RGB luminous module;
which lamp is configured to be set by means of an arrangement for setting at least one RGB luminous module, comprising:
at least one RGB sensor configured to detect a color signal; and
a processor configured to set the at least one RGB luminous module depending on the color signal.

21. A method for setting at least one RGB luminous module, the method comprising:
detecting a color signal using at least one RGB sensor; and
setting the at least one RGB luminous module depending on the color signal using a processor.
